(19) United States
(12) Patent Application Publication
(10) Pub. No.: US 2021/0150901 A1
(43) Pub. Date: May 20, 2021

(54) A TRAINING SYSTEM FOR AUTOMATICALLY DETECTING PARKING SPACE VACANCY

(71) Applicant: PARKAM (ISRAEL) LTD, Tel Aviv (IL)

(72) Inventors: Asaf NAAMANI, Shapira (IL); Ori ATTAR, Modi'in (IL); Ofer HASSON, Meitar (IL)

(21) Appl. No.: 16/623,042

(22) PCT Filed: Jun. 10, 2018
(86) PCT No.: PCT/IL2018/050629

§ 371 Date: Dec. 16, 2019

(30) Foreign Application Priority Data
Jun. 14, 2017 (IL) 252914

(51) Int. Cl. G08G 1/14; G06K 9/62; G06K 9/00; H04N 7/18

(52) U.S. Cl. CPC G08G 1/14; H04N 7/181; G06K 9/00785; G06K 9/6218

(57) ABSTRACT

A system for automatically detect the occupancy of a parking space, comprising: a server adapted to receive images of at least one parking area from one or more cameras, wherein the server is configured for detecting a vacant parking space within the at least one parking area, the server comprising: i) a visual descriptor module for analyzing the obtained images as to detect parking spaces within a parking area and to extract visual descriptor images; ii) a statistical data analyzer for clustering parking space features; iii) a label assigner module for assigning labels for each cluster; and iv) a memory unit for storing said features and the cluster and labels.

### FIELD OF THE INVENTION

The present invention relates to the field of parking place vacancy detection. More particularly, the invention relates to a video based system for determining the vacancy of detected parking spaces.

### BACKGROUND OF THE INVENTION

Searching for a parking space may be a difficult and frustrating task at times. The task becomes even more challenging when searching in a crowded area. A driver has limited knowledge in advance regarding the vacancy of parking spaces until arriving at his location of interest. This can cause waste of time while searching for a vacant parking space, or requires the driver to park in a space which is relatively far away from his location of interest.

Some systems for observing parking spaces utilize video cameras, which obtain images of parking spaces in parking areas. It is difficult, however, to automatically determine from a video image whether or not a parking space is vacant due to changes in shape, color, texture and other parameters of images captured by a video camera. For instance, it would be difficult to determine if a parking space is vacant when a vehicle of the same color as the parking space background is occupying the space.

It would be advantageous to have a video based system for automatically determining whether a parking space is vacant or occupied.

It is therefore an object of the present invention to provide a video based system for automatically determining whether a parking space is vacant or occupied.

Other objects and advantages of this invention will become apparent as the description proceeds.

### SUMMARY OF THE INVENTION

The present invention relates to a system for automatically detect the occupancy of a parking space, comprising: a server adapted to receive images of at least one parking area from one or more cameras, wherein said server is configured for detecting a vacant parking space within said at least one parking area, said server comprising: i) a visual descriptor module for analyzing said obtained images as to detect parking spaces within a parking area and to extract visual descriptor images; ii) a statistical data analyzer for clustering parking space features; iii) a label assigner module for assigning labels for each cluster; and iv) a memory unit for storing said features and said cluster and labels.

According to an embodiment of the invention, the server receives the images from the one or more cameras via communication means in a wireless or wired manner.

According to an embodiment of the invention, the label assigner comprises a car tracking module which uses object tracking algorithms to determine labels for each cluster.

According to an embodiment of the invention, the label assigner comprises an input device adapted to receive manual single frame decisions.

According to an embodiment of the invention, the server further adapted to receive a vacant parking space query from a user, locate a vacant parking space in accordance with said query and return said user the location of the located vacant parking space.

According to an embodiment of the invention, the system further comprises: a) a mapping module for determining the geographical relation between a plurality of parking areas and for determining parking areas close to the user's query; and b) a mobile device application adapted to receive a user's parking area of interest, transmit a vacant parking space query to the server, and in return to receive a vacant parking space location result.

In another aspect, the present invention relates to a method for detecting vacant parking spaces within a parking area, comprising:
a) obtaining images of at least one parking area from one or more cameras;
b) analyzing said obtained images as to detect parking spaces within said at least one parking area;
c) extracting visual descriptor images features for each image of each detected parking space;
d) clustering parking space features and assigning either a vacancy label or an occupancy label to each cluster;
e) obtaining images of a parking area in real real-time and extracting real-time features of parking spaces within said parking area; and
f) associating said real-time features with said clusters.

According to an embodiment of the invention, the real-time feature extracting of parking spaces is performed either manually or automatically using one or more object tracking algorithms.

### BRIEF DESCRIPTION OF THE DRAWINGS

In the drawings:

FIG. 1 shows a graphical representation of two exemplary visual descriptor features that can be extracted from a single parking space;

FIG. 2 shows the graphical representation of FIG. 1 after labels have been assigned to each cluster;

FIG. 3 shows a flowchart describing a process of a training system for automatically detecting parking space vacancy, according to an embodiment of the invention;

FIG. 4 schematically illustrates a training system for automatically detecting parking space vacancy, according to an embodiment of the invention;

### DETAILED DESCRIPTION OF THE INVENTION

The present invention provides a video based system for automatically determining whether a parking space is vacant or occupied.

Accordingly, one or more video cameras are distributed in a parking area. The one or more video cameras are directed towards parking spaces within the parking area. When activated, the one or more video cameras obtain images of the parking area. The images are sent, either by wireless or wired communication means, to a remote server. The remote server includes computer modules adapted to perform various processing procedures with images of a parking area and a local memory unit.

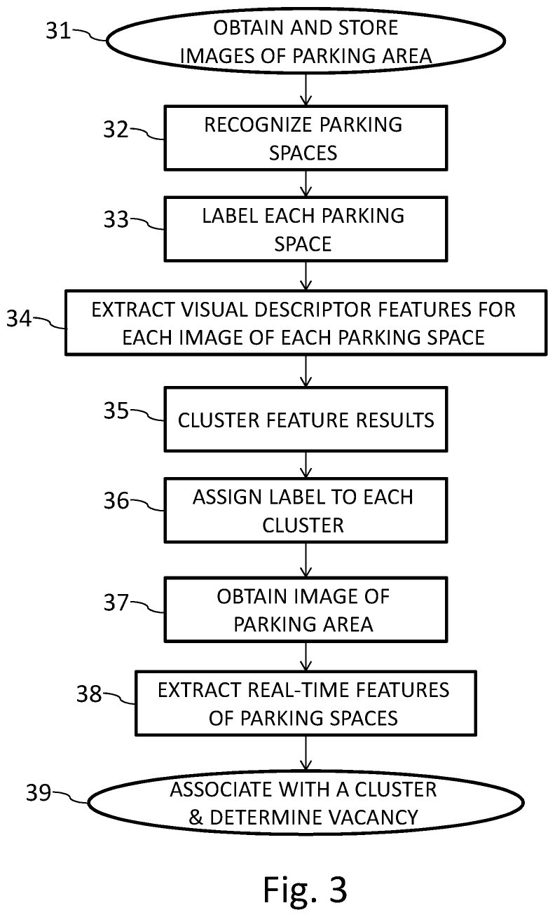

FIG. 3 shows a flowchart describing the process of the invention. At first, a calibration process is performed. After obtaining and storing images of a parking area in step 31, the images are processed in step 32 to recognize parking spaces within the area. Parking space recognition can be performed using any suitable detection methods such as disclosed in WO 2016/174670.

In the next step 33, each recognized parking space is assigned an identification label (ID), for future reference. After recognizing parking spaces, in step 34 a plurality of images are analyzed for extracting a plurality of visual descriptor features of each parking space.

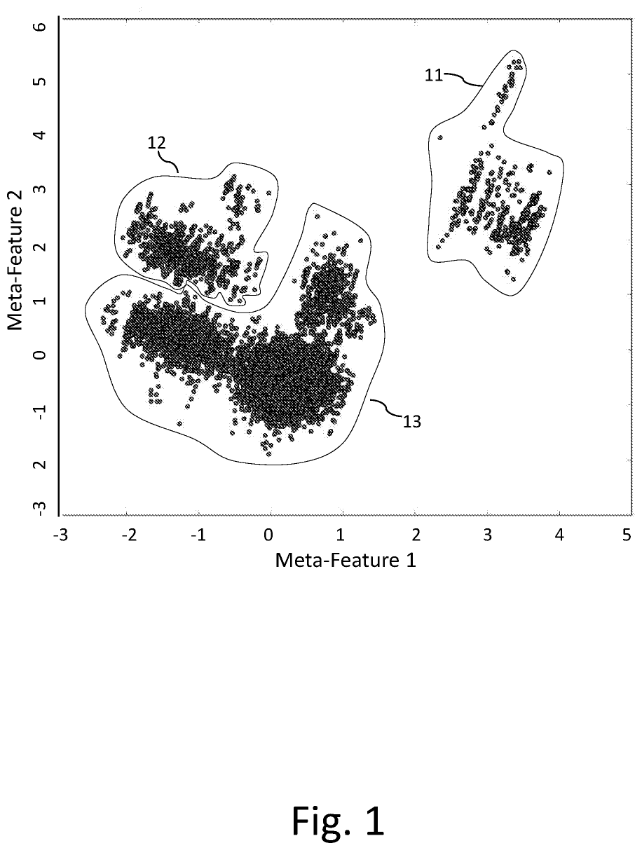

FIG. 1 shows a graphical representation of two exemplary visual descriptor features that can be extracted from a single parking space. The horizontal axis represents a first feature, for example the local binary pattern of each image, and the vertical axis represents a second feature, for example the local phase quantization of each image. It is noted that the system of the invention is not limited to two visual descriptor features as demonstrated in FIG. 1. In fact it is desirable to process each image according to many visual descriptor features known in the art of visual description of images and video.

Each dot within the graph of FIG. 1 represents a sample, i.e. data regarding a single parking space data from a single image. Accordingly, in the next step 35, clusters are created by a statistical data analyzer module. In FIG. 1 three clusters, 11, 12 and 13, are demonstrated. Each cluster represents either the vacancy or the occupancy of the parking space. It is noted that as more visual descriptors are used the clustering is more definite, and clusters are more distinctive from each other.

In order to determine whether a cluster represents parking space vacancy or occupancy, in step 36 a label is assigned to each cluster depicting whether the cluster represents vacancy or occupancy. According to an embodiment of the invention, the labels can be determined by using a car tracking module, which utilizes common object tracking algorithms, as well known in the art to the skilled person. The module obtains images of the parking area and tracks vehicles within the area. For example, the images are analyzed to extract the times at which a vehicle was moving and the times at which it stopped with respect to the region of a parking space. In addition, the visual descriptor features of each image are extracted and are compared to vehicle state data (i.e. stopped or moving) according to the time of the image. Accordingly, the features are labeled and are compared to the previously extracted features, and a label is assigned to each cluster of features.

According to an embodiment of the invention, labeling can be performed manually, i.e. a person can perform a single frame decision, determine whether a parking space is vacant or occupied, and input the determination to the system. The features of the image are extracted and compared to the previously extracted features, and a label is assigned to each cluster of features according to the manually determined label.

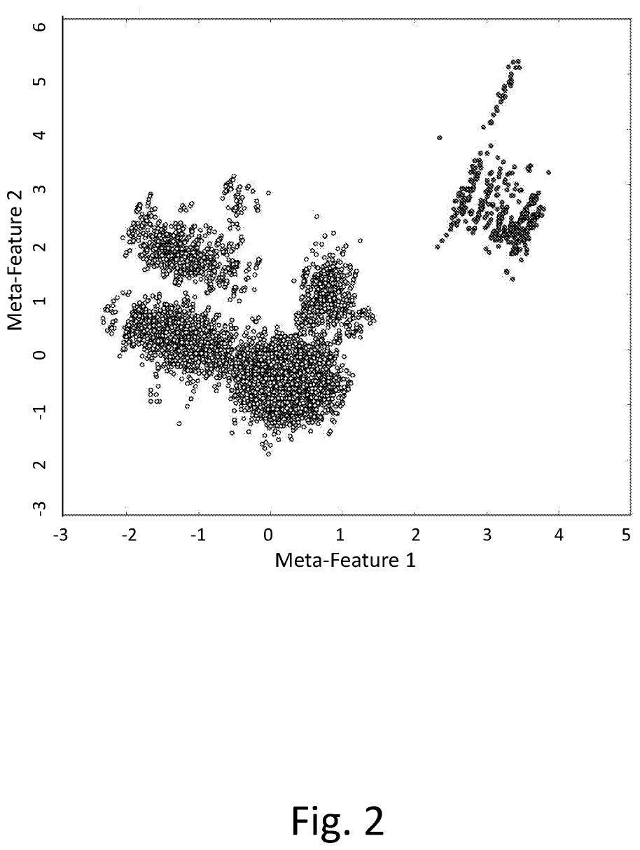

FIG. 2 shows the graphical representation of FIG. 1 after labels have been assigned to each cluster. In FIG. 2, white-filled dots represent vacancy and black-filled dots represent occupancy of a parking space.

Once calibration has been performed, vacant parking spaces and their location within the parking area are detected, by obtaining an image of the parking area in step 37, extracting real-time visual descriptor features of each parking space in step 38, and accordingly in step 39 associating each parking space with a cluster and determining vacancy.

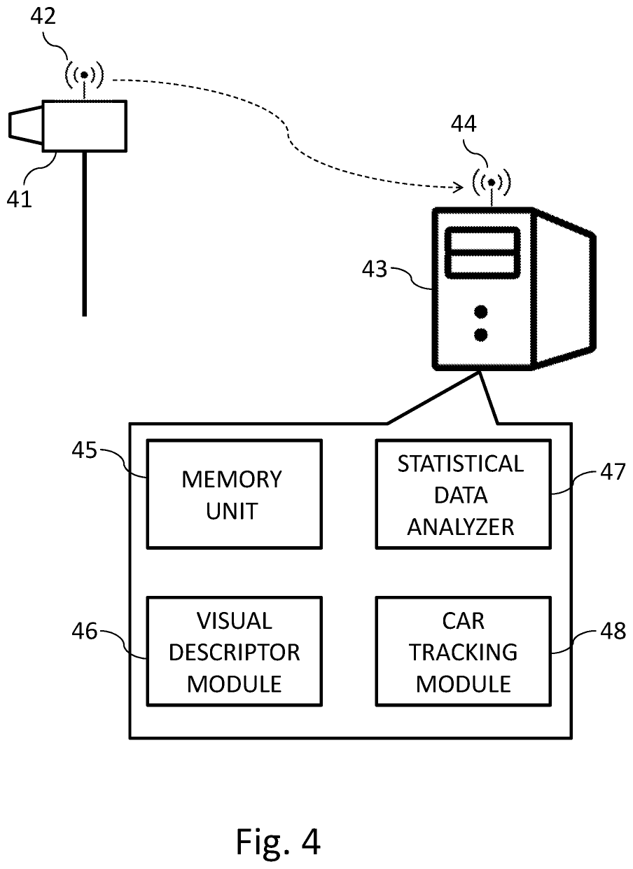

FIG. 4 schematically illustrates the system of the invention. Camera 41 is adapted to obtain images of parking spaces, and send the images to server 43 by wireless communication means 42. It is noted that in other embodiments of the invention, communication between camera 41 and server 43 is performed by wired communication means. Server 43 comprises communication means 44, a memory unit 45 for storing images received from camera 41, a visual descriptor module 46 for analyzing stored images as to detect parking spaces within a parking area and to extract visual descriptor images, a statistical data analyzer 47 for clustering parking space features, and a car tracking module 48 which uses object tracking algorithms to determine labels for each cluster.

According to an embodiment of the invention, a user may submit a query for a vacant parking space in a specific parking area. According to this embodiment, the system of the invention is adapted to accept queries from a user and return the location of a vacant parking space within a requested area. The system is further adapted to locate a vacant parking space in the vicinity of the parking area in case all parking spaces in the parking area are occupied. In this embodiment the system further comprises a mapping module for determining the geographical relation between all parking areas, and for determining parking areas close to that requested by the user. The wireless communication means of the system are used, according to this embodiment, to receive queries from a user and to send parking space locations to the user. The system further comprises, according to this embodiment, a mobile device computer application adapted to detect a user's parking area of interest, transmit a vacant parking space query, and receive a vacant parking space location result.

As various embodiments have been described and illustrated, it should be understood that variations will be apparent to one skilled in the art without departing from the principles herein. Accordingly, the invention is not to be limited to the specific embodiments described and illustrated in the drawings.

1. A system for automatically detect the occupancy of a parking space, comprising: a server adapted to receive images of at least one parking area from one or more cameras, wherein said server is configured for detecting a vacant parking space within said at least one parking area, said server comprising: i) a visual descriptor module for analyzing said obtained images as to detect parking spaces within a parking area and to extract visual descriptor images; ii) a statistical data analyzer for clustering parking space features; iii) a label assigner module for assigning labels for each cluster; and iv) a memory unit for storing said features and said cluster and labels.

2. The system of claim 1, wherein the server receives the images from the one or more cameras via communication means in a wireless or wired manner.

3. The system of claim 1, wherein the label assigner comprises a car tracking module which uses object tracking algorithms to determine labels for each cluster.

4. The system of claim 1, wherein the label assigner comprises an input device adapted to receive manual single frame decisions.

5. The system of claim 1, wherein the server further adapted to receive a vacant parking space query from a user, locate a vacant parking space in accordance with said query and return said user the location of the located vacant parking space.

6. The system of claim 5, further comprising:
a) a mapping module for determining the geographical relation between a plurality of parking areas and for determining parking areas close to the user's query; and
b) a mobile device application adapted to receive a user's parking area of interest, transmit a vacant parking space query to the server, and in return to receive a vacant parking space location result;

7. A method for detecting vacant parking spaces within a parking area, comprising:
a) obtaining images of at least one parking area from one or more cameras;
b) analyzing said obtained images as to detect parking spaces within said at least one parking area;
c) extracting visual descriptor images features for each image of each detected parking space;
d) clustering parking space features and assigning either a vacancy label or an occupancy label to each cluster;
e) obtaining images of a parking area in real real-time and extracting real-time features of parking spaces within said parking area; and
f) associating said real-time features with said clusters.

8. The method of claim 7, wherein said real-time feature extracting of parking spaces is performed either manually or automatically using one or more object tracking algorithms.
